(19) United States
(12) Patent Application Publication
(10) Pub. No.: US 2015/0168305 A1
(43) Pub. Date: Jun. 18, 2015

(54) METHOD OF DETECTING AN ANALYTE IN A SAMPLE USING RAMAN SPECTROSCOPY, INFRA RED SPECTROSCOPY AND/OR FLUORESCENCE SPECTROSCOPY

(71) Applicant: Imperial Innovations Limited, London (GB)

(72) Inventors: Joshua Benno Edel, London (GB); Vladimir Alexander Turek, London (GB); Michael Peter Cecchini, London (GB); Alexel A. Kornyshev, London (GB); Jack Paget, London (GB); Anthony Kucernak, London (GB)

(21) Appl. No.: 14/418,305

(22) PCT Filed: Jul. 30, 2013
(86) PCT No.: PCT/EP2013/065970

§ 371 Date: Jan. 29, 2015

(30) Foreign Application Priority Data
Jul. 8, 2012 (GB) 1213981.2
Jul. 30, 2012 (GB) 1213479.7

(51) Int. Cl. G01N 21/65; G01N 21/64; G01N 21/35

(52) U.S. Cl. CPC G01N 21/658; G01N 21/35; G01N 21/64; G01N 2201/06113; G01N 2201/02

(57) ABSTRACT

The invention relates to a method of detecting the presence of an analyte associated with a nanoparticle layer formed at a liquid-liquid interface. The method comprises removing a portion of one of the liquid phases; and detecting the presence of the analyte by Raman spectroscopy, Infra Red spectroscopy and/or fluorescence spectroscopy. The invention further relates to a kit for use in the method, comprising a sample vessel for receiving in use, a first and second liquid phase; wherein said phases are immiscible and wherein one or both of the first or the second liquid phase comprise nanoparticles, and instructions to allow analysis of an analyte in a sample according to the claimed method

The present application relates to a method of detecting an analyte in a sample using Raman spectroscopy, Infra Red spectroscopy and/or fluorescence spectroscopy, in particular surface enhanced Raman spectroscopy, surface enhanced Infra Red spectroscopy, and/or surface enhanced fluorescence spectroscopy.

Various analytical techniques exist that can be used for molecular detection of pollutants, explosives, narcotics and pesticides. Often “real-samples” contain a complex mixture of compounds, which need to be quantified. Furthermore, they frequently also contain analytes dissolved in various phases (e.g air, oil, and aqueous). This makes identifying chemical species dissolved in multiple phases a real challenge. This problem becomes further amplified when trace analyte detection is required, as the signal from background molecules can swamp the signal from the analyte.

One technique that holds great promise in this regard is surface enhanced Raman spectroscopy, an extremely sensitive technique that can be tailored to provide the detection of specific analytes through their unique vibrational fingerprints. The narrow linewidth of SERS spectra allows for multiple analyte detection within complex mixtures, including trace detection down to the single molecule level. SERS is already an established technique to detect explosives (Sylvia, J. M., Janni, J. A., Klein, J. D. & Spencer, K. M. Analytical Chemistry 72, 5834-5840 (2000), Xu, J. Y. et al. Journal of Raman Spectroscopy 42, 1728-1735, Chemistry—A European Journal 16, 12683-12693, (2010), narcotics (Carter, J. C., Brewer, W. E. & Angel, S. M. Appl Spectrosc 54, 1876-1881, (2000) and Bell, S. E. & Sirimuthu, N. M. The Analyst 129, 1032-1036 (2004)) and pesticides (Shende, C., Gift, A., Inscore, F., Maksymiuk, P. & Farquharson, S. 1 edn (eds Bent S. Bennedsen et al.) 28-34 (SPIE) and Sánchez-Cortes, S., Domingo, C., Garcia-Ramos, J. V. & Aznárez, J. A. Langmuir 17, 1157-1162, (2001)).

The enhancement of the Raman signal comes as a result of exciting localized surface plasmons within metallic nanostructures. Increasing the signal strength further can be achieved by tailoring the metallic substrate, thereby lowering the limits of detection. Of particular note, are two-dimensional arrays of closely packed metallic nanoparticles (NPs) on a substrate or metallic nanocavities. These benefit from multiple hot spots being generated in a uniform fashion over a larger substrate area generating high signal enhancement throughout the entire substrate. Various methods exist to fabricate such structures including lithographic and chemical approaches. Metallic structures can also be fabricated from self assembled non-metallic scaffolds. However minimizing the gap between particles or cavities and the complexity of substrate preparation, while maximizing uniformity is crucial to maximizing the electromagnetic field enhancement. Precise nanofabrication techniques capable of achieving these goals can be costly, time consuming and not scalable. Furthermore, most SERS substrates are difficult to clean after use which is impractical for in-the-field applications. In this context, a disposable, self-assembled nanoparticle layer is highly advantageous for practical applications.

The first aspect of the invention relates to a method of detecting the presence of an analyte associated with a nanoparticle layer, wherein said nanoparticle layer is formed at a liquid-liquid interface, said method comprising
removing a portion of one of the liquid phases; and
detecting the presence of the analyte by Raman spectroscopy, Infra Red spectroscopy and/or fluorescence spectroscopy.

In particular the presence of an analyte is detected by surface enhanced Raman spectroscopy, surface enhanced Infra Red spectroscopy and/or surface enhanced fluorescence spectroscopy.

In a preferred feature of the first aspect of the invention, the liquid phases, nanoparticle layer and associated analyte can be deposited on a solid surface prior to detection of the analyte. The method therefore comprises removing a portion of one of the liquid phases; depositing the liquid phases, nanoparticle layer and associated analyte on a solid surface; and detecting the presence of the analyte by surface enhanced Raman spectroscopy, surface enhanced Infra Red spectroscopy and/or surface enhanced fluorescence spectroscopy.

A portion of one of the liquid phases is removed to minimise the interfacial area, thereby concentrating both the analyte and the nanoparticles at the liquid-liquid interface. Analysis of the nanoparticle bound analyte therefore occurs directly at the liquid-liquid interface. This allows more sensitive and accurate detection of the analyte. The method of the first aspect therefore preferably comprises removing at least half of one of the liquid phases, more preferably removing substantially all of one of the liquid phases. It will appreciated that it may not be possible to remove all of one of the liquid phases and a small amount (for example in the range of 200, 100 or 50 microlitres) of the liquid phase may remain when the remaining liquid phase and nanoparticle layer are deposited on the solid surface. For the purposes of this invention, either of the liquid phases can be removed.

The liquid phases and nanoparticle layer are deposited on a solid surface for analysis by surface enhanced Raman spectroscopy, surface enhanced Infra Red spectroscopy and/or surface enhanced fluorescence spectroscopy. It will be appreciated that the solid surface merely acts as a support for the nanoparticle layer at the liquid-liquid interface. The nanoparticle layer is not directly deposited onto the solid surface. The solid surface can therefore be any surface which is compatible with the surface enhanced detection techniques (for example, a glass surface, a plastic surface). Preferably the solid surface is a cover slip.

The nanoparticle layer is formed by the addition of a first liquid phase to a second immiscible liquid phase, wherein one or both of the first or second liquid phases comprises nanoparticles. The liquid phases are emulsified and a nanoparticle layer is allowed to form at the liquid-liquid interface. It will be appreciated that the first and second liquid phases, phase separate to form a liquid-liquid interface with the nanoparticles sandwiched between them.

As set out above, for the purposes of the first aspect of the invention, the analyte is associated with the nanoparticle layer, formed at a liquid interface. The analyte can be associated with the nanoparticle layer by adding an analyte to an emulsion of a first and second liquid phase wherein one or both of the first or the second liquid phase comprise nanoparticles and allowing the formation of a nanoparticle layer at the liquid-liquid interface.

The analyte can be added directly to the emulsion. Alternatively, the analyte can be added to the first or second liquid phase prior to emulsification of the liquid phases. For example, the analyte can be associated with the nanoparticle layer by
dissolving an analyte in a first liquid phase
adding an immiscible second liquid phase;
   wherein one or both of the first or the second liquid phase comprise nanoparticles,
emulsifying the liquid phases; and
allowing the formation of a nanoparticle layer at the liquid-liquid interface.

In an alternative embodiment, the analyte can be added after the formation of the nanoparticle layer at the liquid-liquid interface. In this case, the method will comprise forming an emulsion from a first liquid phase and an immiscible second liquid phase wherein one or both of the first or second liquid phases comprise nanoparticles, allowing the formation of a nanoparticle layer at the liquid-liquid interface and adding an analyte.

The analyte can bind directly to the nanoparticle layer. Alternatively, the nanoparticle can be functionalised and the analyte can bind via a functional ligand attached to or associated with the nanoparticle. Binding of the analyte either directly to the nanoparticle layer or via a functionalized ligand can be ionic or covalent depending on the identity of the analyte and/or ligand.

The resulting analyte-associated nanoparticle layer is then analysed in accordance with the method set out above.

As set out above, the present invention allows more sensitive and accurate detection of analytes as the density of the nanoparticles and analyte are concentrated at the interface by minimising the interfacial area. The preparation of the nanoparticle layer is therefore preferably prepared using low volumes of the liquid phases. Thus, the first liquid phase is preferably provided in a volume of 1 to 1000 microlitres, preferably 50 to 500 microlitres, more preferably 100 to 150 microlitres. The second liquid phase is preferably provided in a volume of 1 to 1000 microlitres, preferably 50 to 500 microlitres, more preferably 100 to 150 microlitres. The first and second liquid phase are preferably provided in a ratio of 1:1. It will be appreciated, that the preparation of the nanoparticle layer can be prepared in larger volumes, for example where in the first liquid phase is provided in a volume of 10 ml, 100 ml, 1 litre or 10 litres and wherein the second liquid phase is provided in a volume of 10 ml, 100 ml, 1 litre or 10 litres.

The liquid phases can be emulsified by any method known in the art. Preferably, the liquid phases are emulsified by agitation, preferably by rapid shaking for 10 seconds, by sonication or by centrifugation.

The method involves the use of a first liquid phase and a second immiscible liquid phase. For the purposes of this invention, one of the liquid phases can be an ionic liquid or aqueous and one of the liquid phases can be organic. Alternatively, the first liquid phase can be any phase which is immiscible with the organic second phase, for example a silicone oil or a liquid metal. The identity of the first and second liquid phases will depend on the identity of the analyte to be detected. For the purposes of this invention, the organic phase is a non-miscible organic phase, for example aliphatic hydrocarbons (such as hexane), aromatic hydrocarbons (such as toluene), halogenated hydrocarbons (such as dichloromethane or dichloroethane) or an oil. The aqueous phase can be selected from water or a solution of a water soluble solid in water, such as salt in water such as a sodium chloride solution or sugar in water. Where the aqueous phase is provided as a solution of a water soluble solid in water, the aqueous phase can be provided in a concentration of 0.001M to 2M, such as 0.002M to 1.5M, preferably 0.01 M to 1M, more preferably 0.05M to 0.75M, such as 0.1M to 0.5M.

The nanoparticles of the present invention can be metal or non-metal nanoparticles. The nanoparticles can be provided as mixtures of one or more nanoparticles. The nanoparticles are preferably metal nanoparticles. Such nanoparticles can be pure-metal nanoparticles or can be core-shell nanoparticles where the shell is metal. Alternatively, the nanoparticles can be inorganic/metal hybrids such as CdSe/Au or Au/SiO₂. Examples of such metal nanoparticles are selected from gold, silver, copper, platinum, titanium or palladium. Other examples of nanoparticles for the present invention include CdS and CdSe nanoparticles. While particles with any diameter can be used for this method for example from 5 to 100 nm, preferably 10 to 75 nm, more preferably 25 to 50 nm, it will be noted that particles having a diameter of 10 nanometres or greater are particularly preferred. The method can be carried out using particles with any PDI. In particular, where one nanoparticle size is required, nanoparticles having a PDI of 0.3 or lower are particularly preferred. However, this invention also encompasses the use of multiple nanoparticle size populations, for example, nanoparticles of two or more differing sizes can be used in the method. It will be appreciated that in addition to spherical nanoparticles, other shapes such as rods, nanocubes, nanostars, nanoflowers, etc. can be used for the present invention. Preferably, such particles have a diameter (or in the case of a nanorod, a longest dimension) of 5 to 100 nm, preferably 10 to 75 nm, more preferably 25 to 50 nm.

It will be appreciated that the nanoparticles can be functionalised to allow or improve the binding of the analyte. Examples of such functionalisation include citrate stablised particles, particles functionalised with phosphates, sulphates, thiols, dyes, DNA, proteins, antibodies, etc. In addition, the particles may be functionalised with an amine or carboxylate termination group. The functionalised nanoparticle can allow the capture of a specific analyte from a mixed analyte population. Alternatively, a mixed population of nanoparticles can be used, wherein the nanoparticles are functionalised with different functional groups to allow detection of more than one analyte from a sample.

The method of the present invention is provided for the detection of an analyte in a sample, such as a solid or liquid sample. The sample may contain one or more analytes for detection. Alternatively or in addition, the sample may further comprise one or more additional components (such as contaminant, solvents, excipients). Thus, references in this aspect to the addition of the analyte to the nanoparticle layer, to the emulsion or to the liquid phases include the addition of the analyte in a sample. The sample may be a food stuff, or a liquid such as water for example drinking water.

A particular use of the method of the first aspect is the detection of two or more analytes in a sample. For example, the method of the first aspect can therefore be provided for the simultaneous detection of from 1 to 20 analytes, that is 1, 2, 3, 4, 5, 6, 7, 8, 9, 10, 11, 12, 13, 14, 15, 16, 17, 18, 19 or 20.

The method disclosed in the first aspect allows the detection of hydrophilic, hydrophobic, and/or amphiphilic analytes. The method also allows the detection of analytes which are insoluble in both phases as the analyte will absorb to the liquid liquid interface. Examples of such analytes include explosives such as Trinitrotoluene, RDX and HMX, narcotics such as cocaine, heroin, ecstasy, and cannabis and pesticides, such as hexachlorocyclopentadiene derivatives, chlorobenzenes and other organochlorine species and metals, particularly trace metals, such as mercury, silver and lead. The method can be used to detect an analyte embedded within an aqueous or organic (for example an oil) phase.

The method allows the nanoparticles to self-assemble into an array of closely packed spheres creating a multitude of hotspots uniformly distributed within the detection volume and ensuring all captured analyte molecules are at the point of detection. This allows detection of the analytes at levels of 1 femtomole. In some embodiments, the method allows single molecule detection.

The method can be used to detect an analyte embedded within an aqueous, oil, or air phase. The method of the first aspect is particularly provided for detecting the presence of toxins such as explosives, drugs, trace metals or other hazardous chemicals.

The second aspect of the invention relates to a method of detecting the presence of an analyte in a gaseous sample, said method comprising forming a nanoparticle layer at a liquid-liquid interface, removing one of the liquid phases and exposing the nanoparticle layer to the gaseous sample; wherein the presence of the analyte is detected by Raman spectroscopy, Infra Red spectroscopy and/or fluorescence spectroscopy, in particular by surface enhanced Raman spectroscopy, surface enhanced Infra Red spectroscopy and/or surface enhanced fluorescence spectroscopy.

For the purposes of this invention, after removal of one of the liquid phases, the remaining liquid phase and nanoparticle layer are deposited on a coverslip and exposed to the gaseous sample. Detection of the analyte occurs at the nanoparticle layer at the liquid-gas interface.

The nanoparticle layer for the purposes of the second aspect of the invention is formed at the liquid gas interface. In this case, the nanoparticle layer is formed by
adding a first liquid phase comprising nanoparticles to a second immiscible phase;
wherein one of the phases is aqueous and one of the phases is organic
emulsifying the liquid phases;
allowing formation of a nanoparticle layer at the liquid-liquid interface;
allowing the removal of the organic phase.

The organic phase can be removed or can be allowed to evaporate. The nanoparticle layer is then exposed to the gaseous sample whereby the analyte becomes associated with the nanoparticle layer. In a particularly preferred feature of the second aspect of the invention, the gaseous sample is air. The method of the second aspect of the invention is therefore particularly provided for the detection of airborne analytes.

The method of the first and second aspect of the invention allows the analysis of samples in an in-field environment. In particular, the third aspect of the invention provides a kit for detecting an analyte in a sample, said kit comprising:

a sample vessel for receiving in use, a first and second liquid phase; wherein said phases are immiscible and wherein one or both of the first or the second liquid phase comprise nanoparticles, and instructions to allow analysis of an analyte in a sample according to the methods of the first or second aspect of the invention. The kit may additionally comprise a solid surface for receiving the sample prior to analysis by Raman spectroscopy, Infra Red spectroscopy and/or fluorescence spectroscopy, in particular surface enhanced Raman spectroscopy, surface enhanced Infra Red spectroscopy and/or surface enhanced fluorescence spectroscopy.

The analysis of an analyte in a sample is carried out using an optical device tuned to detect fluorescence and/or Raman and/or IR. The fourth aspect of the invention therefore relates to the use of an optical device in the method of the first or second aspect of the invention.

Where detection of the analyte is by surface enhanced Raman spectroscopy, the optical device may comprise:
A light source;
Optics to focus the light onto the sample and collect the Raman scattered signal
Filters
a spectrograph; and
an imaging device

For the purposes of the invention, the light source is a nearly monochromatic light source, which is provided to excite the surface plasmons within the nanoparticle array. The light source may additionally excite the adsorbed analyte on the nanoparticle surfaces if the analyte has a specific absorbance.

The filters are provided to remove the intense Rayleigh line that would saturate a sensitive detector. The spectrograph is provided to disperse the Raman scattered light into its individual wavelength components. The imaging device can be either a charged coupled device (CCD) or photodiode depending on the spectral resolution required

In a particular embodiment of the present invention, the Raman spectrometer is a portable palm top fibres couples raman spectrometer. Excitation is carried out at a wave length determined by the type of nanoparticle. Excitation is carried out using a laser line near the localised surface plasmon resonance (LSPR) maximum of the array. This increases the electric field generated by the nanoparticles within the array, increases the signal intensity, thereby allowing reduced analyte concentrations to be measured. The LSPR will be different depending on the nanoparticles (i.e. silver or gold), shape (i.e. spherical, rod, cube) and packing (spacing). Additionally for more sensitive measurements, the laser line could be tuned to match the resonance of the analyte. Additionally, operating in the near Infra red reduces fluorescence generation.

A variable laser power between 5-50 mW is used. This increases the limits of detection, as the Raman scattered intensity is proportional to the 4^{th} power of the incident light intensity. A spectral range of 200-2400 cm⁻¹ is used. This allows for the full vibrational spectrum of the analyte to be measured. This gives better precision in the measurement because it ensures that the vibrational spectrum of the desired analyte is being recorded, not that of a contaminate. The large spot size of the laser (<0.2 mm) takes advantage of the uniformity of the substrate. The backscattering geometry allows for the nanoparticle array to be completely exposed to the air gathering the analyte, while real-time monitoring is being performed. Finally, the data can be downloaded from the spectrometer to a computer for post processing and analysis. Similar detection techniques can be employed to detect fluorescence and IR signals. Depending on the detection method used, different excitation sources, filters and detectors may be required.

All preferred features of each of the aspects of the invention apply to all other aspects mutatis mutandis.

The invention may be put into practice in various ways and a number of specific embodiments will be described by way of example to illustrate the invention with reference to the accompanying drawings, in which:

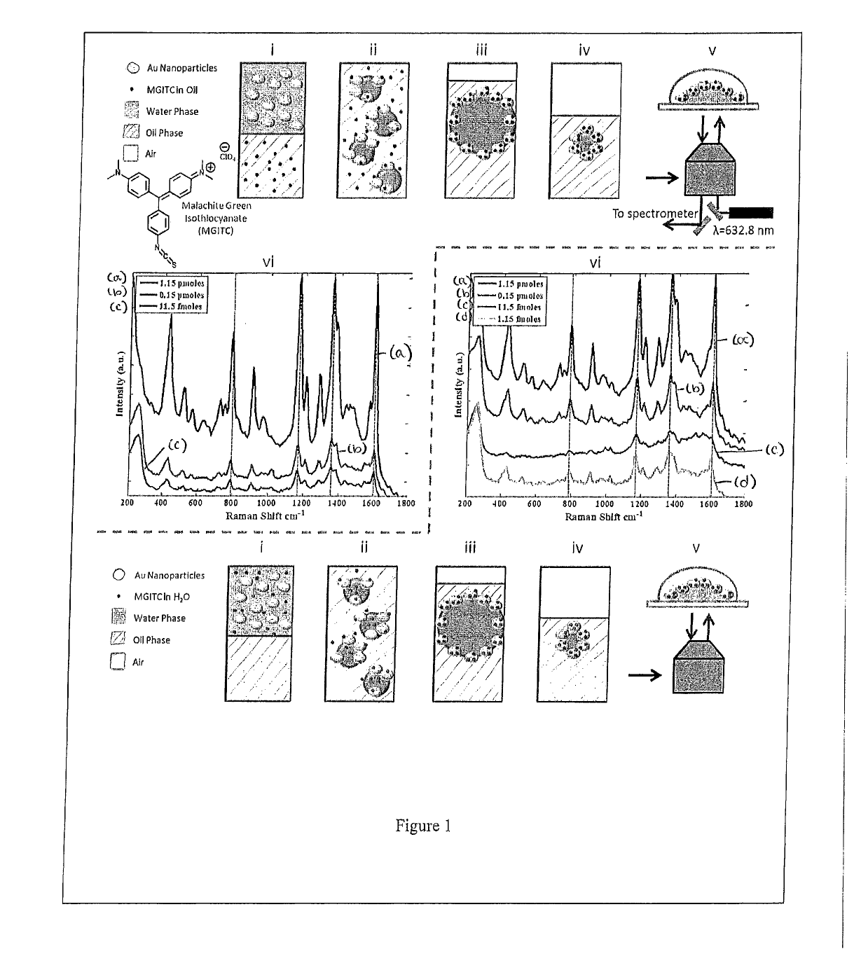

FIG. 1 illustrates in (A i-v) a schematic of LLI formation incorporating NPs and MGITC; wherein

(A i) The analyte is loaded into the oil phase and NPs in the aqueous phase;

(A ii) Vigorous agitation causes the formation of an emulsion;

(A iii) The small emulsion droplets rearrange to form a LLI consisting of NPs and MGITC;

(A iv) The emulsion is allowed to separate out into two distinct phases prior to one of the phases being removed. Water is removed from the droplet bringing the NPs close together;

(A v) The droplet is transferred on to a coverslip.

Part (A vi) of FIG. 1 illustrates the surface enhanced Raman spectra showing a dilution series of MGITC adsorbed to the NPs at the LLI.

Parts (B i-vi) of FIG. 1 illustrate a corresponding scheme in which MGITC is initially dissolved in the aqueous phase.

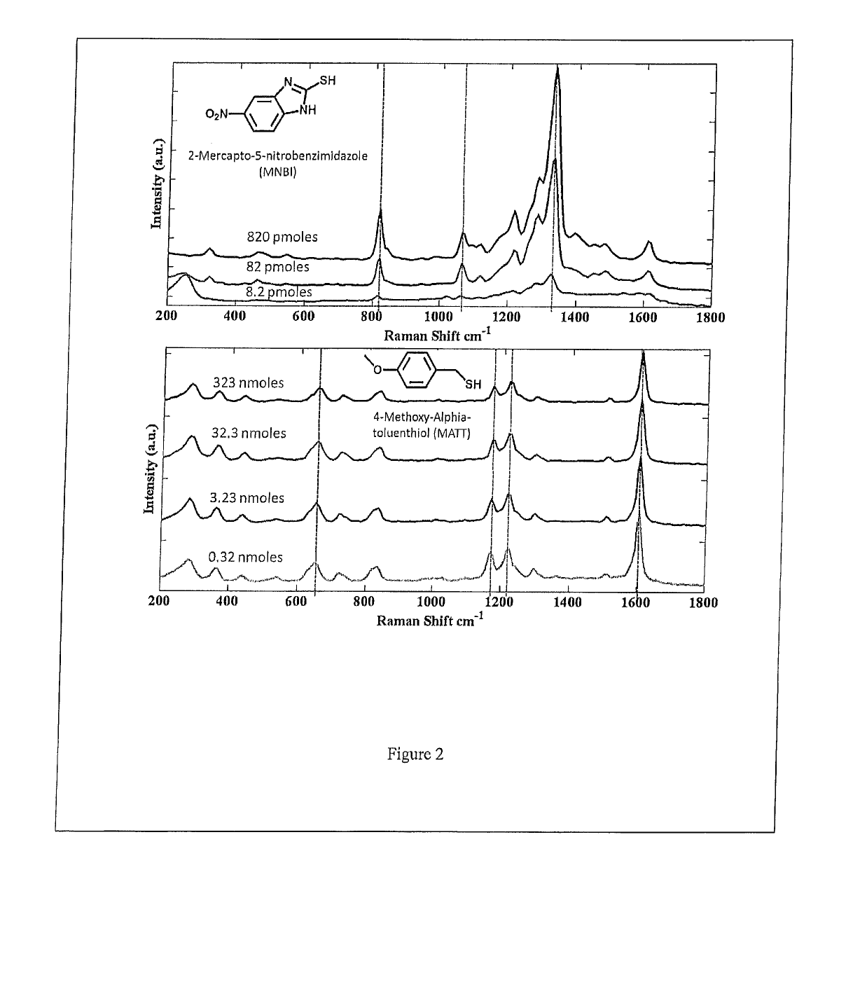

FIG. 2 illustrates (A) surface enhanced Raman spectra showing a dilution series of MNBI adsorbed to the NPs at the LLI. Initially MNBI was dissolved in the aqueous phase;

(B) Surface enhanced Raman spectra showing a dilution series of MATT adsorbed to the NPs at the LLI. MATT was initially dissolved in the oil phase.

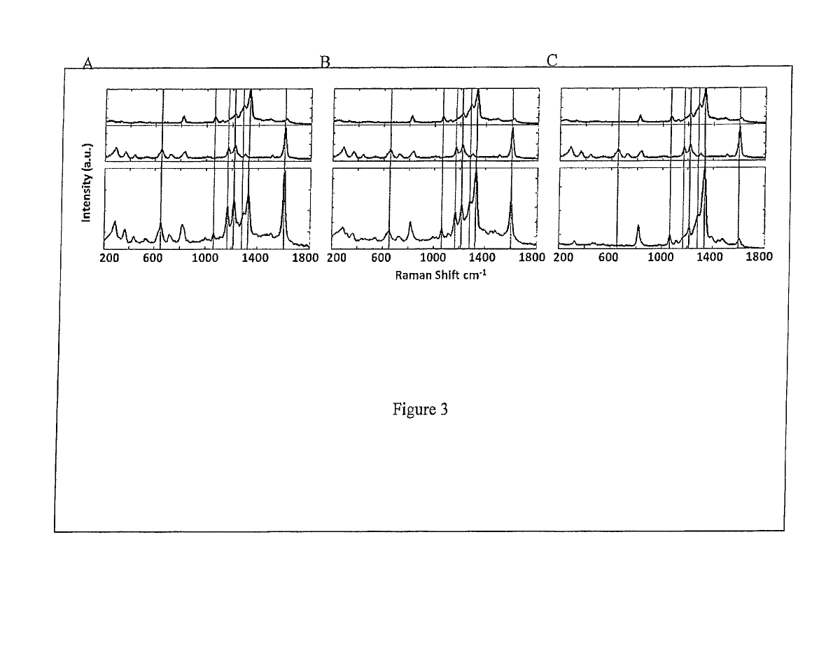

FIG. 3 illustrates SERS spectra showing dual analyte detection (bottom) at the LLI for a mole ratio (MATT:MNBI) of (A) 20:1 (B) 2:1 and (C) 1:20. As a reference SERS spectra of pure MNBI (top) and MATT (middle) are also shown.

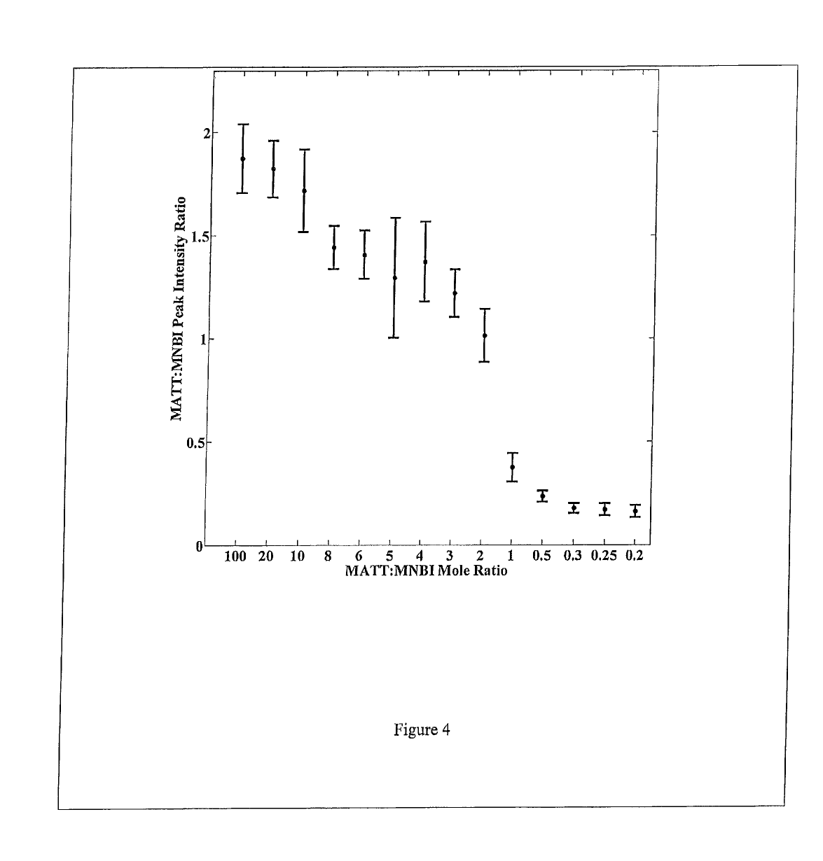

FIG. 4 illustrates a comparison of the intensity ratio of the 1604 cm-1 vibrational band of MATT and the 1333 cm-1 vibrational band of MNBI as a function of the mole ratio.

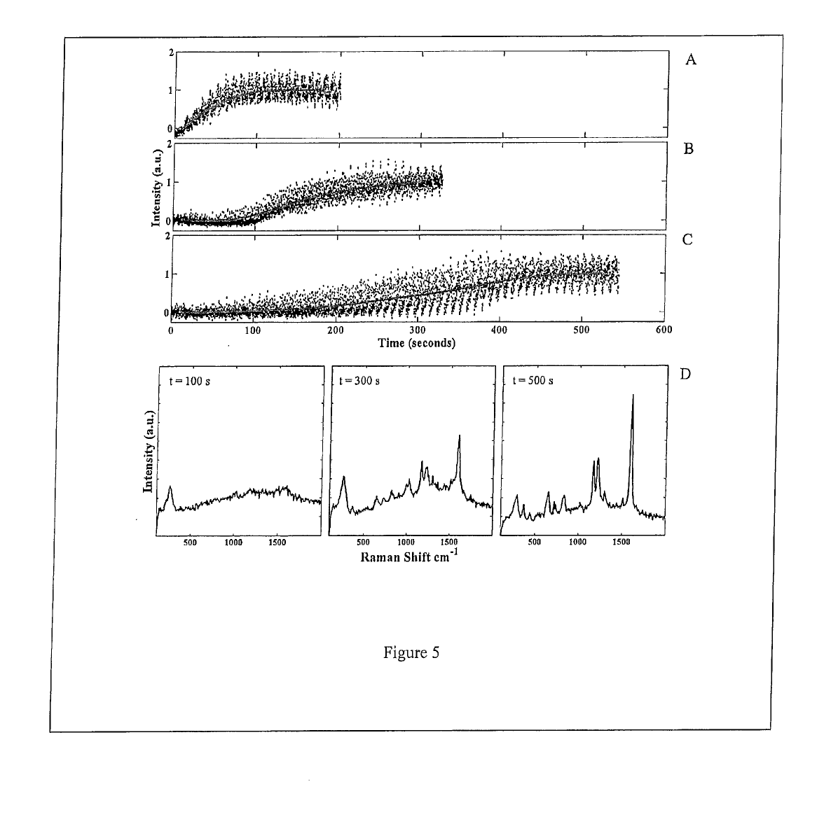

FIG. 5 illustrates the detection of airborne MATT at the LAI. A 5 microL drop of MATT was placed at (A) 10, (B) 15 and (C) 20 mm away from the interface and the 1175 cm-1 vibrational band was monitored as a function of time. The traces clearly show that the initial slope decreases with increasing distance between the LAI and MATT. A plateau is also observed which is a result of the NPs being saturated with MATT. Examples of full SERS spectra at three different time points in (C) are shown in (D).

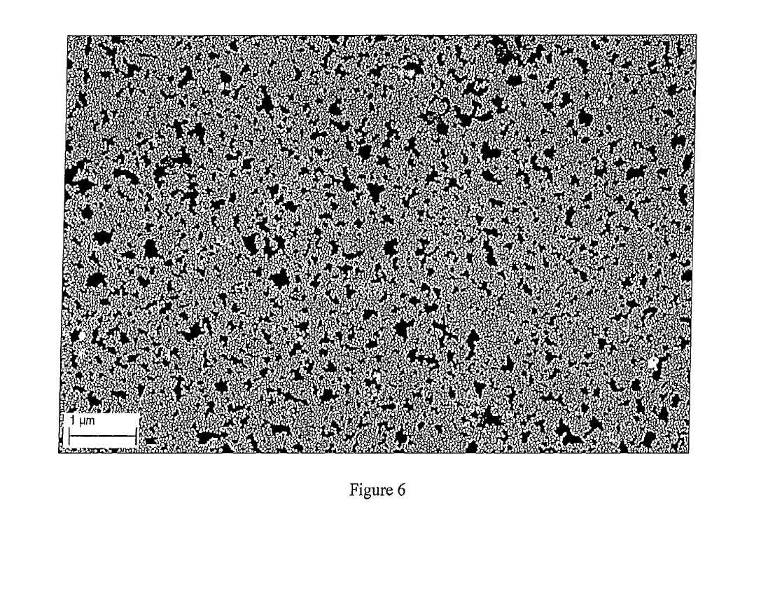

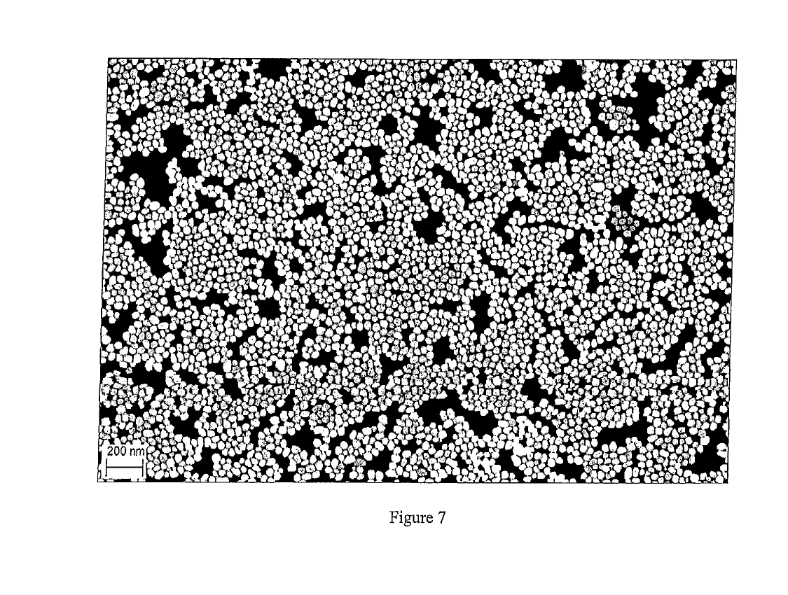

FIGS. 6 and 7 illustrate the SEM image of the 43±4 nm Au NPs used for the experiments at different resolutions;

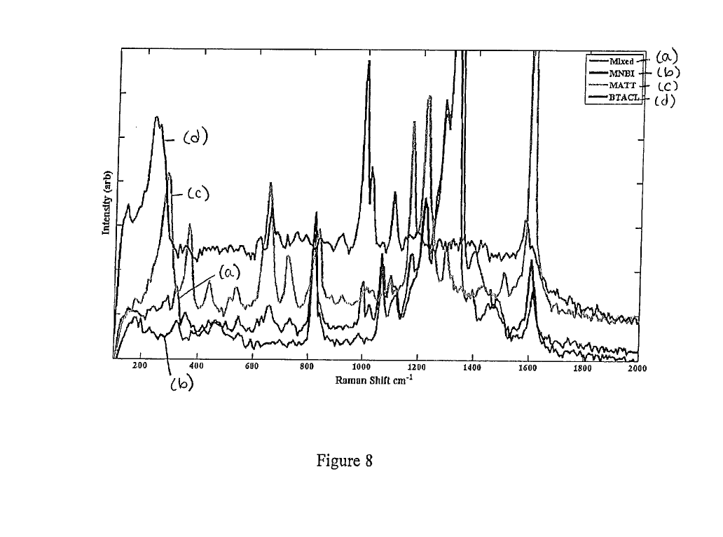

FIG. 8 shows the analysis of a tri-analyte mixture of MNBI, MAT and bis(triphenylphosphoranylidene)ammonium chloride (BTACL), with the analysis of the single analytes for comparision wherein (a) is the tri-analyte mixture, (b) is MNBI, (c) is MAT and (d) is BTACL.

The present invention will now be illustrated by reference to one or more of the following non-limiting examples.

### EXAMPLES

### Abbreviations

NP nanoparticles
DCE dichloroethane
LLCI liquid liquid interface
LAI liquid air interface
SERS surface enhance Raman spectroscopy

### Methods

### Nanoparticle Synthesis

Citrate stabilized Au NPs were synthesized using the Turkevich-Frens method (Turkevich, J. Discussions of the Faraday Society 11, 55 (1951) and Frens, G. Nature 241, 20 (1973)). The particles used in this work had an average hydrodynamic diameter of 64.7±30.5 nm with a polydispersity index (PDI) of 0.268 as measured using DLS. An extinction coefficient, εmax, at 532 nm of 1.31×1010 M-1 cm-1 (Liu, X., Atwater, M., Wang, J. & Huo, Q. Colloids and Surfaces B: Biointerfaces 58, 3-7, (2007)) was assumed for the 43 nm diameter NPs (from SEM). This value was used for all NP concentration evaluations using UV-Vis. The concentration of the particles was adjusted using DI water for dilutions and centrifugation for concentration to a final working concentration of approximately 31.9 pM or 4.35×10¹⁰ NPs/mL.

### Optical Configuration

SERS measurements were performed on a homebuilt Raman microscope (Cecchini, M. P., Stapountzi, M. A., McComb, D. W., Albrecht, T. & Edel, J. B. Raman Spectroscopic Events. Anal. Chem. 83, 1418-1424, (2011)). Briefly, a 632.8 nm HeNe laser (HRP170, Thorlabs, 17 mW) excitation source was guided through two cleanup filters (LL01-633-12.5, Semrock) into an optical inverted microscope (IX71, Olympus). A linear polarizer (PRM1/M, Thorlabs) controlled the light polarization direction on the sample. The laser light was reflected into a 40× air objective (LUCPLANFLN, Olympus, NA 0.6, 4 mm WD) using a dichroic mirror (D1, LPD01-633RU-25×36×2.0, Semrock) mounted at a 45° angle of incidence. A long working distance objective was required to reach the NP assembly. The laser intensity at the sample was measured to be 8.5 mW using a digital power meter (PM100, Thorlabs). Backscattered light was collected through the same objective and transmitted through the same dichroic mirror. A long pass filter (LP1, LP02-633RU-25, Semrock) was used to reject the anti-Stokes scattered light and Rayleigh laser line. A Ø1″lens (LA1805-B, f=30 mm, Thorlabs) focused the transmitted light onto the 50 μm entrance slit of the spectrograph (303 mm focal length, Shamrock SR-303i, Andor). The polychromatic light was then dispersed by a 600 l/mm grating (SR3-GRT-0600-0500, Andor) where it was imaged using an Electron Multiplying Charge Coupled Device (EMCCD, Newton DU970BV, Andor). All spectra were acquired using a 100 ms exposure time. In all experiments, after assembling the substrate on the coverslip, the substrate was searched by moving the stage to find areas where the signal could be detected. At higher concentrations, signal was emitted from all areas within the substrate. At lower dilutions, the uniformity in the signal intensity diminished, as the coverage of analyte with the probe volume was not uniform.

### Details of Ocean Optics PinPointer Raman Spectroscopy Device.

Excitation wavelength: 785 nm Laser power: <5 mW Raman spectral range: 200-2400 cm-1 Spectral resolution: ˜10 cm-1 Raman shift stability: <1 cm-1 in 12 hours Photometric stability: <4% in 12 hours Collection optics: NA=0.28, working distance=5 mm spot size <0.2 mm Power: Rechargeable battery, wall plug transformer 100-240 V AC 50/60 Hz Size: 8.5″×4.3″×2.5″ Weight: 3 lb.

### Analyte Preparation

### Malachite Green Isothiocyanate (MGITC)

3 μL of 0.388 mM MGITC was dissolved in either 1000 μL of fresh DCE or water. 100 μL of this solution was added with 400 μL of the solvent (either water or DCE) providing 0.116 (±11.1-11.6%) nmole for detection (at the highest concentration). This was followed by 10-fold serial dilutions using 100 μL of the previous solution and diluting with 900 μL of the solvent. Again 100 μL were added to 400 μL of either the oil or aqueous phase for the subsequent sample. This dilution methodology was performed for all samples.

4-Methoxy-α-toluenethiol (MATT)

5 μL of the oil soluble molecule, MATT, was initially diluted with 995 μL of DCE. 100 μL of this solution was added with 400 μL of fresh DCE providing 3.23E-6 moles for detection. 10-fold serial dilutions followed using 100 μL of the previous dilutions sample and diluting with 900 μL of fresh DCE.

The solubility of MATT in water is calculated to be 0.74 g/L. The solubility of MATT in DCE or log PDCE/wat is not available, however the log Poct/wat is calculated to be 2.474±0.238 (at 25° C.) and the polar surface area is 48.0 Å2. This means that the majority of the MATT will be dissolved in the hydrophobic (DCE) phase.

Mercapto-5-nitrobenzimidazole (MNBI)

Serial dilutions were performed using the stock analyte concentration and diluting with water. 0.16 mg 2-Mercapto-5-nitrobenzimidazole (MNBI, Sigma) was initially diluted with 10 mL of water. Subsequently, 100 μL of this was mixed with 400 μL of NPs. 10-fold serial dilutions followed using 100 μL of the previous sample and diluting with 900 μL of water. 100 μL of that was added to 400 μL of NPs.

The solubility of MNBI in water is calculated to be 0.43 g/L. The solubility of MNBI in DCE or log PDCE/wat is not available, however the log Poct/wat is calculated to be 1.404±0.738 (at 25° C.), while the polar surface area is 102 Å2. This means that MNBI is likely to have a greater mole fraction in water than MATT.

Note: solubility, log P and polar surface area values for MATT and MNBI obtained through SciFinder—calculated by Advanced Chemical Development (ACD/Labs) Software V11.02 (© 1994-2012 ACD/Labs)).

### Self-Assembly of the NPs at the LLI.

The method used throughout this work is aimed towards a practical, in-the-field usable device. With this in mind, the SERS ‘sensor’ was made using cost-effective and simple methods that require no specialized equipment or qualified personnel. Self-assembly of a thin film of NPs at the LLI was achieved by vigorously shaking a 2 mL polypropylene tube for approximately 10 seconds consisting of 0.5 mL of 1,2-dichloroethane (DCE) and a 0.5 mL aqueous solution. The aqueous solution consisted of 20 mM NaCl and 43±4 nm (based on NP area—see FIGS. 6 and 7) diameter Au NPs with an aspect ratio of 1.35±0.22 at a concentration of 4.35±0.02×1010 particles per mL. The physical steps towards generating a NP film at the LLI is shown in FIG. 1 A (i-v) and FIG. 1B (i-v). After shaking, the resulting emulsion quickly separated into two distinct phases with the formation of a thin layer of self-assembled NPs between the two phases. A golden reflection was observed at the DCE/water interface suggesting NP localization. While there are a number of alternative methods for NP assembly at the LLI, such as (m)ethanol addition and electrochemistry, emulsification was used throughout this work due to its simplicity and cost effectiveness. Assembly of the NPs relies on the spontaneous diffusion-limited NP localization to the LLI as well as an increased efficiency of assembly with increasing ionic strength of the aqueous phase. The emulsification process played two key roles, the first being a reduction in the average distance between the NPs and the LLI, thereby speeding up the diffusion limited localization to the interface; while the second was a reduction of the average distance of the analytes to the LLI and hence the NPs, allowing efficient analyte capture.

The exact structure of the layers of NPs at the LLI is extremely difficult to assess; however, the 2D nature of the dried assembly is evident from SEM images (FIGS. 6 and 7). After thin-film formation, all but 50 μL of the aqueous phase was removed (FIG. 1A (iv)). This step increases the particle density at the LLI resulting in an aqueous droplet being formed consisting of NPs at the perimeter. The total number of NPs in the sample was determined to be 1.74±0.05×1010. The actual number of NPs assembled at the LLI was confirmed to be in the range of 1.39×1010 to 1.71×1010 as calculated by UV-Vis spectroscopy. To perform SERS measurements the sample was transferred onto a 130-160 μm thick coverslip (FIG. 1. A (v)) which resulted in the NPs forming a thin film (in this case the aqueous phase was below the NPs and the oil phase above). The diameter of the LLI interface once placed on the coverslip was approximately 5 mm.

### Analyte Loading on the Nanoparticles.

As a feasibility study, the reporter fluorophore malachite green isothiocyanate (MGITC) was used as the target analyte. This dye was chosen due the resonance enhancement that can be achieved since MGITC absorbs light near the 632.8 nm wavelength of excitation source used in the experiments which increases the intensity of the Raman signal. Furthermore, at low concentrations MGITC is soluble in both the aqueous and oil phases respectively. Therefore, MGITC was used to test the performance and assess whether the platform was capable of detecting analytes in either phase. The method of LLI formation in this case is identical to what is described above with the exception of analyte incorporation. This was simply performed by initially dissolving MGITC in the oil phase (prior to shaking) at varying initial concentrations ranging from 115±14 pmole to 1.15±0.37 fmole in 10-fold increments (FIG. 1 A (i-v)). At the highest MGITC concentration, there were approximately 4.03±0.48×103 dye molecules bound to 1 NP assuming MGITC was homogenously distributed across all NPs at the LLI. At the lowest concentration, there were on average 4.03±1.30×10-2 MGITC molecules per NP. Examples of the surface enhanced resonant Raman scattering (SERRS) spectra for these samples at the LLI are shown in FIG. 1A (vi). As expected a decrease in analyte concentration resulted in a decrease in the total count intensity rate. For example, comparing the intensities of the 1170 cm-1 vibrational band for the 1.15±0.23 pmole and 11.5±3.2 fmole samples, the peak intensity decreased by 99%. Although even lower limits of detection (LODs) were achieved, the spectra there were not reproducible, the variance in the detected signals affected, presumably, by random fluctuations in the morphology of the NP arrays or/and by defects in the NP-analyte conjugation. For practical purposes≈10 fmole LOD was reached for reproducible SERS signals of MGITC dissolved in DCE. Similarly, a further experiment was performed with MGITC dissolved in the aqueous phase (FIG. 1B (i-vi)). This showed a 10-fold improvement, with an LOD of 1.15±0.30 fmole, when compared to the previous case. This is likely due to MGITC in the aqueous phase having a direct route in order to bind to the NPs.

To test the versatility and the sensitivity of the system, non-resonant analytes were also used. The first example was a water soluble analyte, mercapto-5-nitrobenzimidazole (MNBI), FIG. 2A. Concentrations down to 8.20±1.81 pmole could be detected which equates to approximately 347±63 MNBI molecules bound per NP. Compared to MGITC the LOD using MNBI was lower as a result of no resonance enhancement. We expect the binding efficiency to be similar between MGITC and MNBI, as both form strong bonds with the gold NPs. Finally, a DCE soluble analyte, 4-methoxy-α-toluenethiol (MATT) was used to quantify the detection limits of a non-resonant analyte dissolved in the oil phase. The spectra can be seen in FIG. 2B. It is interesting to note that unlike analytes dissolved in the aqueous phase, the LOD was much higher, 323±91 pmole. This is likely due to the different binding chemistry taking place across the phase boundary. For example, MNBI is able to bind to the NP's surface prior to the NP adsorbing to the LLI, whereas the majority of MATT will only bind once the NPs are assembled at the LLI.

### Simultaneous Multi-Phase Analyte Detection at the LLI.

Successfully independently detecting analytes dissolved in either the water or oil phase using the same sensor design presented the opportunity for simultaneous dual-phase-dual-analyte (DPDA) detection. From a sensor perspective, the unique ability to dress the NPs with analytes with different solubilities across multiple phases simultaneously offers a unique prospect in building a universal sensor. Furthermore, from more of a chemical perspective, this multi-phase system can also be used to decorate a NP surface with both aqueous- and oil-phase soluble analytes simultaneously. This allows for direct control of not only the analyte type but the relative concentrations of different analytes on the NP surface. This is a significant advantage when compared to a solid-state substrate. Whilst solid-state substrates can potentially conjugate analytes from either phase, to detect both analytes, the conjugation processes would have to be separated. As such, there is little control over the relative analyte concentration on the NPs. Furthermore, the NPs on a solid-state surface are irreversibly bound, whereas a solution based system allows for the surface to be regenerated.

To characterize the LOD of simultaneous binding of analytes from both the oil and aqueous phases, the mole ratio of MNBI and MATT dissolved in each phase was precisely defined. MATT:MNBI was varied between 8.20 nmole:82 pmole (100:1) to 82.0 pmole:8.20 nmole (1:100). As an example, the effect of the mole ratio on the SERS intensity of the two analytes can be seen in FIG. 3A-C, for mole ratios of 20:1, 2:1 and 1:20. In all spectra it is clear that the vibrational bands of both analytes could be seen and detected. For example, the 651, 1169, 1224, and 1604 cm-1 bands of MATT could easily be distinguished from the 1064, 1285, and 1333 cm-1 bands of NMBI. Furthermore, the relative intensities correlated nicely with the analyte concentration. While fluctuations in intensity did occur during the acquisition, the vibrational bands from both analytes resulted in equal enhancement which suggests their equal distribution across all NPs. The intensity of the MATT and MNBI vibrational bands were proportional to the concentration of each analyte dissolved in each phase. This was verified by comparing the average intensity ratio between the 1604 cm-1 vibrational band of MATT and the 1333 cm-1 of MNBI (FIG. 4). Notably the mole ratio has been varied by over 3 orders of magnitude.

### Self-Assembly of the NPs and Analyte Loading and Detection at the LAI.

A significant advantage of the system described herein relates to the possibility in converting the NPs embedded at a LLI to a LAI. This exciting prospect allows the detection of volatile or gaseous compounds. The LAI is simply produced by allowing the DCE phase at the LLI to evaporate. This process effectively removes the oil phase from the system whilst keeping the NPs at the interface; therefore, once the DCE has evaporated a LAI with NPs embedded between the two phases is the resultant product (FIG. 5.A). To test the capabilities of this platform, a 5 μL drop of pure MATT was placed 10, 15 and 20 mm away from the point of detection on the sensor. A continuous acquisition was performed monitoring the 1175 cm-1 vibrational band of MATT using a 100 ms exposure time at an acquisition rate of 10 Hz. The intensity of this band as a function of time was plotted and is shown in FIG. 5 (A-C) for each distance. A smoothing function was applied to each time trace to assist in post analysis shown in red. As expected, at the start of each acquisition, no MATT is detected. For the 10 mm separation (FIG. 5A), the onset occurred as soon as the MATT drop was placed on the coverslip, while for the 15 (FIG. 5B) and 20 (FIG. 5C) mm separations the onset started at approximately 100 and 200 seconds respectively. This increase is followed by a plateau due to analyte saturation bound to the NPs after 100, 200, and 300 s from the onset. This is intuitive seeing as the concentration of an evaporating analyte in the air will be dependent on the distance from the point of evaporation, therefore the ‘slope’ of the increasing signal can be used to estimate the concentration of the analyte in the air. The slope decreased from 0.013 to 0.006 to 0.003 when the analyte droplet was moved from 10 to 15 to 20 mm from the nanoparticle film. Estimating the concentration of analyte on the NPs can be accomplished by comparing the SERS intensity to that acquired by the LLI system.

### Scanning Electron Microscopy of Nanoparticle Monolayer

A monolayer was deposited on a glass cover slip by vigorously shaking a 0.51 mL aq. NP solution containing 2.18×1010 NPs at a NaCl concentration of 20 mM with 0.5 mL DCE, followed by a reduction in the aqueous volume to 50 μL and dilution of the aqueous salt concentration by 2 consecutive 1 mL ultrapure water additions/1 mL aqueous phase extractions (this step prevents the formation of salt crystals during the drying process). The resulting 50 μL droplet was then transferred to a glass coverslip and as much of the water was removed as possible by pipetting (the water's contact area with the glass remained roughly constant during this volume reduction) and finally allowing the water to dry at ambient conditions for about 5 minutes. The glass coverslip was then secured to an SEM stub with carbon tape and silver paint was applied between the edge of the monolayer and the aluminium stub to provide an electrical path of conductivity. No further treatment (such as sputtering a thin layer of conductive metal on the coverslip) was required to obtain the SEM, suggesting that there is a good lateral conductivity throughout the film (although certain regions where an insufficient contact was made between the NPs displayed charging—an example of this is the isolated cluster in the top left hand corner of the 200 nm scale-bar-image). Though the morphology of the NP packing at the liquid/liquid or liquid/air interface will likely be substantially different to that which is observed on the dry monolayer, it is evident that there is a 2 dimensional NP array with a multitude of NPs in close enough proximity to each other to be able to plasmonically couple and provide a roughly uniform distribution of SERS hot-spots.

Gold nanoparticles prepared by the Turkevich-Frens method of this size show some shape polydispersity. In order to calculate the average core diameter, ImageJ was used to calculate the average area per NP. This area was then used to calculate the average diameter of the NPs if they were perfectly spherical. This is the reason for the large discrepancy between the DLS hydrodynamic diameter reading of 64.7±30.5 nm and the 43±4 nm quoted from SEM.

A remarkable feature of the NP sensor at the LLI is the ability to detect dual analytes dissolved in dual phases simultaneously, which we have successfully demonstrated by detecting water-soluble and organic-phase-soluble molecules—MGITC, MATT, and MNBI. Other thiolated and unthiolated molecules dissolved in either the water or oil phase were also tried with similar success. This new option eliminates the need for multiple devices, reducing analysis time and offering multiplexing capabilities. The technique directly compares the SERS intensity of multiple analytes. We have shown that the mole ratios of both analytes play an important role in the SERS intensity of individual vibrational bands. Such a dependency allows direct comparison of mole ratios, using known and unknown analyte quantities. An additional advantage of the sensor is the ability to use it at the LAI to detect airbourne analytes.

1. A method of detecting the presence of an analyte associated with a nanoparticle layer, wherein said nanoparticle layer is formed at a liquid-liquid interface, said method comprising
removing a portion of one of the liquid phases; and
detecting the presence of the analyte by Raman spectroscopy, Infra Red spectroscopy and/or fluorescence spectroscopy.

2. The method of claim 1 wherein the presence of the analyte is detected by surface enhanced Raman spectroscopy, surface enhanced Infra Red spectroscopy and/or surface enhanced fluorescence spectroscopy.

3. The method of claim 1 where at least half of one of the liquid phases is removed.

4. The method of claim 1 where substantially all of one of the liquid phases is removed.

5. The method of claim 1 where the liquid phases, nanoparticle layer and associated analyte are deposited onto a solid surface prior to detection of the analyte.

6. The method of claim 1 wherein the nanoparticle layer is formed by the addition of a first liquid phase to a second immiscible liquid phase, wherein one or both of the first or second liquid phases comprises nanoparticles, emulsifying the liquid phases and allowing the formation of a nanoparticle layer at the liquid-liquid interface.

7. The method of claim 6 where the analyte is associated with the nanoparticle layer by the addition of the analyte to the emulsion of a first and second liquid phase; or by the addition of the analyte to the first or second liquid phase prior to emulsification of the liquid phases; or by the addition of the analyte after the formation of the nanoparticle layer at the liquid-liquid interface.

8. The method of claim 6 wherein the liquid phases are emulsified by agitation, by sonication or by centrifugation.

9. The method of claim 1 wherein one of the liquid phases is aqueous and one of the liquid phases is organic.

10. The method of claim 1 wherein the nanoparticles are pure-metal nanoparticles or can be core-shell nanoparticles where the shell is metal and said metal is gold, silver, copper, platinum, titanium or palladium.

11. A method of detecting the presence of an analyte in a gaseous sample, said method comprising forming a nanoparticle layer at a liquid-liquid interface, removing one of the liquid phases and exposing the nanoparticle layer to the gaseous sample, wherein the presence of the analyte is detected by Raman spectroscopy, Infra Red spectroscopy and/or fluorescence spectroscopy.

12. The method of claim 11 wherein the presence of the analyte is detected by surface enhanced Raman spectroscopy, surface enhanced Infra Red spectroscopy and/or surface enhanced fluorescence spectroscopy.

13. The method of claim 11 wherein the nanoparticle layer is formed by
adding a first liquid phase comprising nanoparticles to a second immiscible phase; wherein one of the phases is aqueous and one of the phases is organic
emulsifying the liquid phases;
allowing formation of a nanoparticle layer at the liquid-liquid interface;
allowing the removal of the organic phase.

14. The method of claim 13 wherein the organic phase is removed by evaporation.

15. A kit comprising:
a sample vessel for receiving in use, a first and second liquid phase; wherein said phases are immiscible and wherein one or both of the first or the second liquid phase comprise nanoparticles, and
instructions to allow analysis of an analyte in a sample according to claim 1.

16. A kit as claimed in claim 15 additionally comprising:
a solid surface for receiving the sample prior to analysis by Raman spectroscopy, Infra Red spectroscopy and/or fluorescence spectroscopy, or by surface enhanced Raman spectroscopy, surface enhanced Infra Red spectroscopy and/or surface enhanced fluorescence spectroscopy.
